(19) United States
(12) Patent Application Publication
(10) Pub. No.: US 2004/0111896 A1
(43) Pub. Date: Jun. 17, 2004

(54) Hanger bracket for hair clipper

(76) Inventor: Marcus W. David, Granite Quarry, NC (US)

Correspondence Address: Adams, Schwartz & Evans, P.A., 2180 Two Wachovia Center, Charlotte, NC, 28282, US

(21) Appl. No.: 10/320,653

(22) Filed: Dec. 16, 2002

(51) Int. Cl. B26B 19/48

(52) U.S. Cl. 30/298.4; 30/231

(57) ABSTRACT

A storage bracket for an electric hair trimmer, including a plate for being releasably secured to a cutting head on the trimmer and an opening defined by the plate and adapted for receiving a support member therethrough for suspending the bracket from the support member, thereby placing the trimmer in a stored position when not in use.

### TECHNICAL FIELD AND BACKGROUND OF THE INVENTION

This invention relates to a hanger bracket for an electric hair trimmer particularly intended to protect the wires enclosed within the electrical cord of the trimmer by reducing stress on the wires at the point at which the electrical cord is attached to the base of the trimmer. In many instances, barbers or hair stylists must work and store the tools of their trade within a cramped booth or other work area having limited storage space. Since storage space is at a premium, many stylists resort to hanging as many tools as possible along the sides of the booth to clear away counter space for items not suited for hanging. Unfortunately, some tools which are not designed to be hung are often suspended from convenient points within a booth in various and innovative ways.

An electric hair trimmer is one tool frequently subjected to such abuse. With a long electrical cord conveniently trailing from its base, the standard electric hair trimmer is a device that is often inappropriately hung by its cord inside a booth or work area. Strapped for space and time, a stylist may find it easy to improvise and suspend the trimmer from the cord, which ultimately causes the cord to fray and bend where it connects to the base of the trimmer. This damage eventually creates a short circuit requiring repair or premature replacement of the trimmer.

The hanger bracket used in the present invention results in a safe and inexpensive alternative to the damage and loss associated with improperly hanging a hair trimmer by its electrical cord. The invention uses commonly available materials and components which may be easily and inexpensively manufactured and supplied to the user in many different forms, and takes advantage of attaching the bracket to the stationary portion of the head of an electrical hair trimmer. The bracket includes a ring adapted to receive a hook or other supporting object from which the hair trimmer may be suspended. The hook may be attached to a cabinet, an appliance holder, wall or other suitable surface. A hair trimmer which includes the bracket of the present invention may be suspended from a hook and easily grasped by the barber or stylist and removed from the hook for use.

### SUMMARY OF THE INVENTION

Therefore, it is an object of the invention to provide a bracket for attachment to an electric hair trimmer particularly intended to protect the wires enclosed within the electrical cord of the trimmer by reducing stress on the wires at the point at which the electrical cord is attached to the base of the trimmer.

It is another object of the invention to provide a bracket for attachment to an electric hair trimmer to facilitate suspending the trimmer from a supporting object without using the electrical cord.

It is another object of the invention to provide a bracket for attachment to an electric hair trimmer which is inexpensive and easy to manufacture from commonly available components.

It is another object of the invention to provide a bracket for attachment to an electric hair trimmer which permits the trimmer to be moved and suspended from a variety of suitable supporting objects in multiple locations.

It is another object of the invention to provide a bracket for attachment to an electric hair trimmer which results in reduced damage, loss and repair costs associated with short circuits in the wiring of hair trimmers whose electrical cords have been used to repeatedly improperly suspend the trimmers from supporting objects.

These and other objects of the invention are achieved in the preferred embodiments disclosed below by providing a storage bracket for an electric hair trimmer. The bracket includes a plate for being releasably secured to a cuffing head on the trimmer. An opening is defined by said plate and is adapted for receiving a support member therethrough for suspending the bracket from the support member, thereby placing the trimmer in a stored position when not in use.

According to one preferred embodiment of the invention, the plate includes a side extension through which the opening extends for positioning the trimmer in spaced-apart relation to and extending outwardly away from the support member when placed in the stored position.

According to another preferred embodiment of the invention, the plate is formed to span a predetermined area of an upper surface of the cutting head for distributing the weight of the trimmer evenly across the plate when the trimmer is in the stored position.

According to yet another preferred embodiment of the invention, the bracket is formed of metal.

According to yet another preferred embodiment of the invention, the bracket is formed of steel.

According to yet another preferred embodiment of the invention, the bracket is formed of plastic.

According to yet another preferred embodiment of the invention, a storage bracket for a hair trimmer having a cuffing head with a blade connected thereto is provided that includes a plate for being releasably secured to the cutting head of an electric trimmer. An eye is carried by the plate and adapted for receiving a support member therethrough for suspending the bracket from the support member and placing the trimmer in a stored position when not in use.

According to yet another preferred embodiment of the invention, the plate is releasably secured to the cutting head adjacent a peripheral edge thereof opposite the blade.

According to yet another preferred embodiment of the invention, the eye is integrally formed with an outer edge of the plate.

According to yet another preferred embodiment of the invention, the the plate includes an outer edge having a shape complementary to the shape of the peripheral edge of the cutting head for permitting the outer edge of the plate and the peripheral edge of the cutting head to be mated together in edge-to-edge, aligned registration with each other.

According to yet another preferred embodiment of the invention, the storage bracket includes at least one threaded bore defined by the plate and adapted for receiving a complementary threaded screw therethrough for securing the plate to the cutting head.

According to yet another preferred embodiment of the invention, a hair trimming assembly is provided. The hair trimming assembly includes an electric hair trimmer having a head affixed to one end and an electrical cord affixed to and extending from the other end. A hanger bracket is also included. The hanger bracket includes a plate releasably secured to the head of the trimmer. An eye is carried by an outer edge of the plate and extends outwardly away therefrom. The eye is adapted for receiving a support member therethrough for suspending the bracket from the support member, thereby placing the trimmer a stored position when not in use and preserving the life of the electrical cord.

An embodiment of the method of storing an electric hair trimmer when not in use according to the invention includes the steps of providing an electric hair trimmer having a head affixed to one end and an electrical cord affixed to and extending from the other end and providing a support member from which the hair trimmer may be hung in a stored position when not in use. A bracket is also providing for placing the hair trimmer on said support member. The bracket includes a plate for being releasably secured to the head of the trimmer and an eye carried by an outer edge of the plate and extending outwardly away therefrom. The eye is adapted for receiving the support member therethrough for suspending the bracket from the support member. The method also includes the steps of securing the plate to the head of the trimmer, and suspending the bracket from the support member by extending the support member through the eye, thereby placing the trimmer in the stored position and preserving the life of the electrical cord.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a perspective view of a bracket and electric hair trimmer according to one embodiment of the invention;

FIG. 2 is a perspective view of a bracket according to one embodiment of the invention;

FIG. 3 is an exploded perspective view of a hair trimmer apparatus according to one embodiment of the invention during assembly;

FIG. 4 is a perspective view of the hair trimmer apparatus shown in FIG. 3 after assembly; and

FIG. 5 is an environmental perspective view of the hair trimmer apparatus shown in FIGS. 3 and 4.

### DESCRIPTION OF THE PREFERRED EMBODIMENT AND BEST MODE

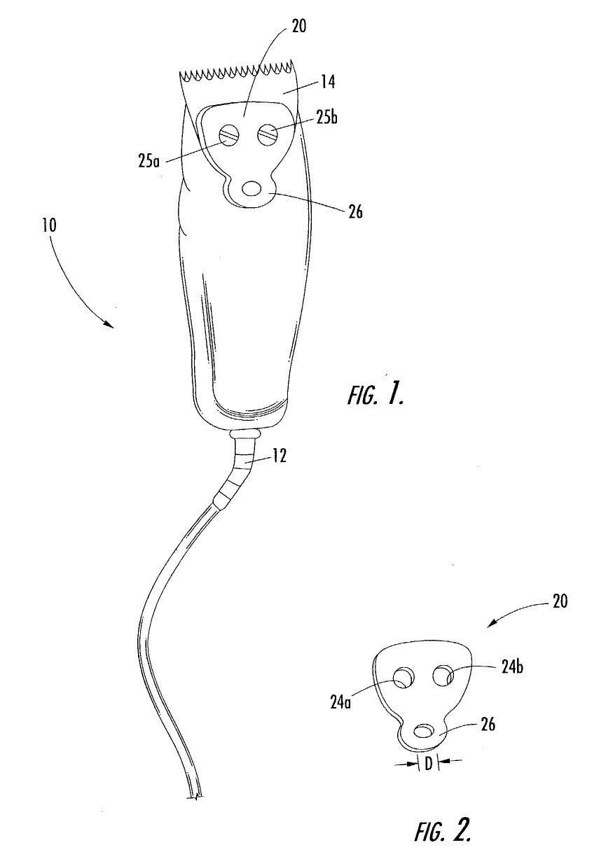

Referring now to FIG. 1, an electric hair trimmer apparatus according to the present invention is illustrated and shown generally at reference numeral 10. The hair trimmer 10 includes an elongate body which holds electrical components therein (not shown) and which may be used as a handle for holding the hair trimmer 10 during use. Mounted to the bottom and top of the hair trimmer 10 are an electrical cord 12 and a head 14, respectively. The cord 12 extends outwardly from the bottom of the hair trimmer 10. The hair trimmer 10 may be any suitable electric hair trimmer generally available on the market.

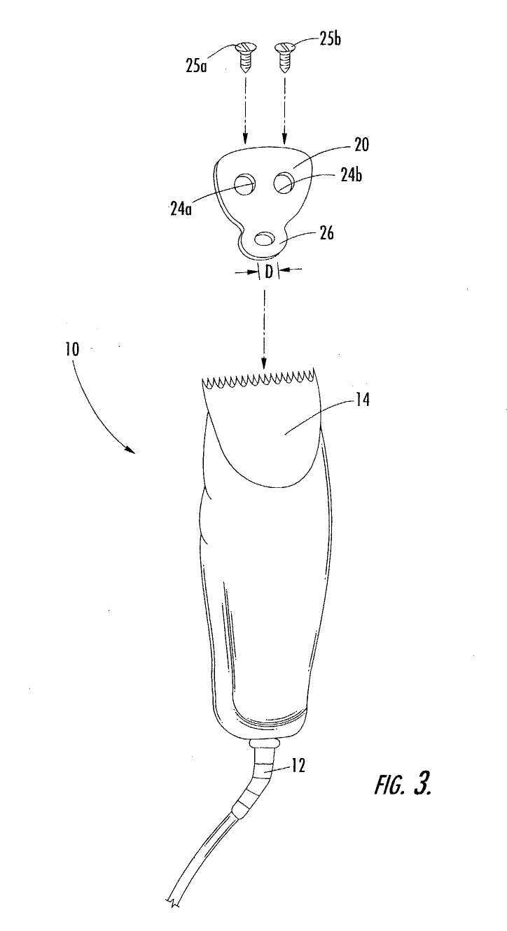

As shown in FIG. 1, the hair trimmer 10 also includes a bracket 20 adapted for being attached to the head 14. Although the bracket 20 may be of any shape or size, the bracket 20 preferably has a shape whose perimeter generally corresponds to the shape of the outer edge of the head 14 of the hair trimmer 10 to which the bracket 20 is attached. The bracket 20 includes at least two holes 24a and 24b (see FIG. 2), therein through which respective complementary screws 25a and 25b are extended for securing the bracket 20 to the head 14. The bracket 20 also includes a ring 26 integrally formed therein for receiving a hook therethrough from which the trimmer may be suspended. The interior diameter “D” of the ring 26 is preferably at least ¼ inch.

Referring now to FIG. 2, the bracket 20 is shown alone and prior to attachment to the hair trimmer 10. The bracket 20 is preferably formed from a high-density plastic such as polyethylene or polypropylene, or a durable metal such as steel. While the bracket 20 may be of any thickness, a preferred thickness is at least ⅛ inch. As shown in FIG. 2, the bracket 20 includes two holes 24a and 24b therein for receiving respective complementary screws 25a and 25b therethrough. Each hole 24a and 24b preferably has a diameter of at least ⅛ inch.

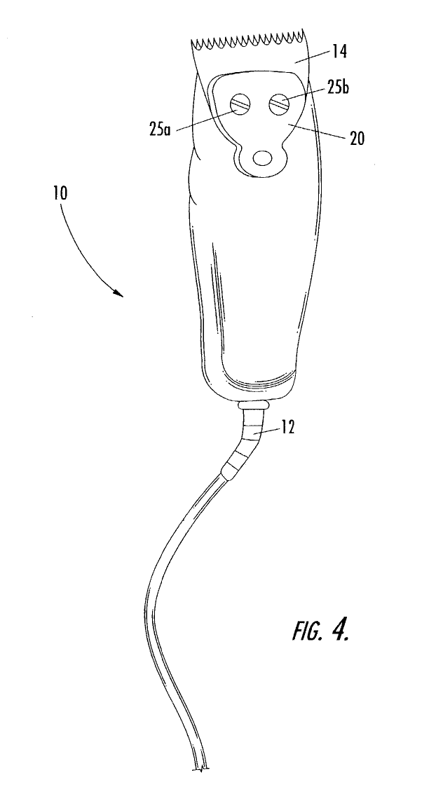

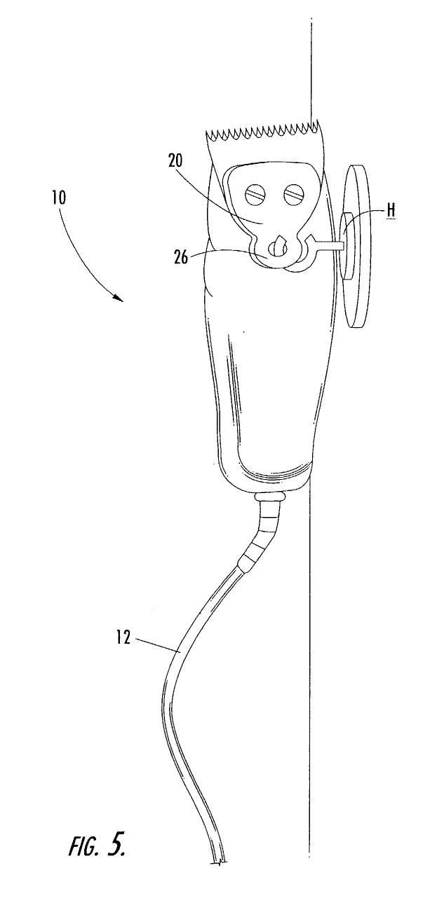

Referring now to FIGS. 3 and 4, the hair trimmer 10 and bracket 20 are shown during and after assembly. In FIG. 3, the bracket 20 is shown positioned above the trimmer 10 and ready for attachment to the head 14. Screws 25a and 25b are likewise shown positioned above the bracket 20 and aligned with complimentary holes 24a and 24b, respectively. FIG. 4 shows the hair trimmer 10 and bracket 20 after assembly, with screws 25a and 25b extended through the complementary holes 24a and 24b and securing the bracket 20 to the head 14.

Referring now to FIG. 5, the hair trimmer 10 is shown suspended from a hook “H” and in a stored position. The hook “H” is preferably a hook having an upwardly-curved end; however, the hook “H” may be any suitable object from which the hair trimmer 10 may be securely suspended. FIG. 5 shows the hair trimmer 10 with the hook “H” placed through the ring 26 of the bracket 20. Suspending the hair trimmer 10 in this manner allows the electrical cord 12 to hang downwardly, which prevents the wiring (not shown) inside the cord 12 from being damaged, and preserves the mechanical life of the trimmer 10.

A bracket for facilitating suspension of an electrical hair trimmer from a hook without relying upon the electrical cord of the trimmer has been disclosed. Various details of the invention may be changed without departing from its scope. Furthermore, the foregoing description of the preferred embodiments of the invention and the best mode for practicing the invention are provided for the purpose of illustration only and not for the purpose of limitation—the invention being defined by the claims.

I claim:

1. A storage bracket for an electric hair trimmer, comprising:
(a) a plate for being releasably secured to a cutting head on the trimmer; and
(b) an opening defined by said plate and adapted for receiving a support member therethrough for suspending said bracket from the support member, thereby placing the trimmer in a stored position when not in use.

2. A storage bracket according to claim 1, wherein said plate further comprises a side extension through which said opening extends for positioning the trimmer in spaced-apart relation to and outwardly away from the support member when placed in the stored position.

3. A storage plate according to claim 1, wherein said plate is formed to span a predetermined area of an upper surface of the cutting head for distributing the weight of the trimmer evenly across the plate when the trimmer is in the stored position.

4. A storage bracket according to claim 1, wherein said bracket is formed of metal.

5. A storage bracket according to claim 1, wherein said bracket is formed of steel.

6. A storage bracket according to claim 1, wherein said bracket is formed of plastic.

7. A storage bracket for an electric hair trimmer having a cutting head with a blade connected thereto, said storage bracket comprising:
(a) a plate for being releasably secured to the cutting head; and
(b) an eye carried by said plate and adapted for receiving a support member therethrough for suspending said bracket from the support member and placing the trimmer in a stored position when not in use.

8. A storage bracket according to claim 7, wherein said plate is releasably secured to the cutting head adjacent a peripheral edge thereof opposite the blade.

9. A storage bracket according to claim 7 or 8, wherein said eye is integrally formed with an outer edge of the plate.

10. A storage bracket according to claim 9, wherein the plate includes an outer edge having a shape complementary to the shape of the peripheral edge of the cutting head for permitting said outer edge of the plate and the peripheral edge of the cutting head to be mated together in edge-to-edge, aligned registration with each other.

11. A storage bracket according to claim 1 or 7, and including at least one threaded bore defined by said plate and adapted for receiving a complementary threaded screw therethrough for securing the plate to the cutting head.

12. A storage bracket according to claim 7, wherein said bracket is formed of metal.

13. A storage bracket according to claim 7, wherein said bracket is formed of steel.

14. A storage bracket according to claim 7, wherein said bracket is formed of plastic.

15. A hair trimming assembly, comprising:
(a) an electric hair trimmer having a head affixed to one end and an electrical cord affixed to and extending from the other end; and
(b) a hanger bracket, including:
(i) a plate releasably secured to said head; and
(ii) an eye carried by an outer outer edge of said plate and extending outwardly away therefrom, said eye adapted for receiving a support member therethrough for suspending said bracket from the support member, thereby placing the trimmer a stored position when not in use and preserving the life of the electrical cord.

16. A method of storing an electric hair trimmer when not in use, comprising the steps of:
(a) providing an electric hair trimmer having a head affixed to one end and an electrical cord affixed to and extending from the other end;
(b) providing a support member from which said hair trimmer may be hung in a stored position when not in use;
(b) providing a bracket for placing the hair trimmer on said support member, said bracket including:
(i) a plate for being releasably secured to said head of the trimmer; and
(ii) an eye carried by an outer edge of said plate and extending outwardly away therefrom, said eye adapted for receiving the support member therethrough for suspending said bracket from the support member;
(c) securing said plate to the head of the trimmer;
(d) suspending the bracket from the support member by extending the support member through the eye, thereby placing the trimmer in the stored position and preserving the life of the electrical cord.
